(19) United States
(12) Patent Application Publication
(10) Pub. No.: US 2002/0098294 A1
(43) Pub. Date: Jul. 25, 2002

(54) Method of providing a protective coating on a metal substrate, and related articles

(76) Inventors: Yuk-Chiu Lau, Ballston, NY (US); Melvin Robert Jackson, Niskayuna, NY (US); Theodore Robert Grossman, Hamilton, OH (US); Adrian Maurice Beltran, Ballston Spa, NY (US); Colleen Marie Rimlinger, San Diego, CA (US); John Herbert Wood, St. Johnsville, NY (US); Sonja Lynn Olson, Burnt Hills, NY (US); Surinder Singh Pabla, Rexford, NY (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(21) Appl. No.: 09/499,165

(22) Filed: Feb. 7, 2000

(51) Int. Cl. B05D 1/36; C23C 4/08

(52) U.S. Cl. 427/454; 427/142; 427/455; 427/456

(57) ABSTRACT

A primary layer of an MCrAlY-type material is first applied to a metal-based substrate by a vacuum plasma spray (VPS) technique, or by HVOF. A secondary layer is then also applied by VPS or HVOF. It is formed of the following alloy (in atom percent): 0 to about 25 cobalt; about 7 to 25 chromium; about 18 to about 55 aluminum; 0 to about 1 yttrium; and 0 to about 2 silicon, with the balance comprising nickel. The applied layers are then heat-treated. Related articles are also described.

### BACKGROUND OF THE INVENTION

This invention generally relates to protective coatings applied to metal substrates. In some specific embodiments, it relates to the application of such coatings to superalloy components used in turbine engines.

Many metals and metal alloys are employed in a wide variety of industrial applications. Very often, the industrial environment includes extreme operating conditions, e.g., temperatures which are generally in the range of about 850° C.-1150° C. When metals like superalloys are exposed to such temperatures, the propensity for corrosion and oxidative attack increases. Thus, protective coatings must be used to protect components made from such metals, e.g., turbine engine components.

One particular coating system which is often used to protect such components includes two layers. The first layer is formed of a material like MCrAlY, where M is iron, nickel, or cobalt. This layer is advantageously applied by a high velocity oxy-fuel (HVOF) technique, and is tightly bound to the substrate. The second layer is an aluminide-type material, which provides the substrate with a much greater degree of oxidation resistance. Usually, the second layer is applied by an aluminiding technique such as “pack aluminiding”. In such a process, the substrate is immersed within a mixture (or pack) containing the coating element source, filler material, and a halide energizer. At high temperatures (usually about 700-1050° C.), reactions within the mixture yield an aluminum-rich vapor which condenses onto the surface being coated, e.g., the MCrAlY-coated substrate. During a subsequent heat treatment, the condensed aluminum-based material diffuses into the MCrAlY coating.

These types of aluminiding techniques are usually quite effective for applying a coating of good quality. However, their use sometimes leads to disadvantages in the overall coating process. For example, pack aluminiding of large parts can require lengthy process times. Moreover, very specialized equipment is necessary for these types of processes. Thus, it may not be possible to apply the coating in a repair operation when the component is at a site without such equipment. Moreover, the “switch-over” time in changing from the coating system used to apply the first layer (e.g., MCrAlY) to that used for the aluminide-based layer sometimes detracts from the overall efficiency of the coating process.

It should thus be apparent that new methods for efficiently applying protective coating systems to metal components would be welcome in the art. The methods should include coating techniques that do not require highly specialized equipment. For example, the equipment used should be that which is available at a variety of sites at which the component may be repaired. Moreover, use of these new methods should result in protective coatings which have properties substantially equivalent to those achieved with coating methods of the prior art.

### SUMMARY OF THE INVENTION

One embodiment of this invention is directed to a method for providing environmental protection to a metal-based substrate, e.g., one formed of a superalloy material. As used herein, “environmental protection” refers to protection of a metal substrate from various adverse effects, e.g., oxidation and corrosion. Thus, the processes claimed herein are especially suitable for protecting turbine engine components which may be exposed to extreme operating conditions, including temperature exposure which is often in the range of about 700° C. to about 900° C. The primary embodiment comprises the following steps:

(a) applying a primary layer to the substrate by a vacuum plasma spray technique or by a high velocity oxy-fuel technique, wherein the primary layer material comprises an alloy of the formula MCrAlY, where M is selected from the group consisting of Fe, Ni, Co, and mixtures of any of the foregoing;

(b) applying a secondary layer to the primary layer by a vacuum plasma spray technique or by a high velocity oxy-fuel technique, wherein the secondary layer material comprises an alloy of the following formula: 0 to about 25 atom % cobalt; about 7 atom % to about 25 atom % chromium; about 18 atom % to about 55 atom % aluminum; 0 to about 1 atom % yttrium; and 0 to about 2 atom % silicon, with the balance comprising nickel; and then

(c) heat-treating the applied layers.

The heat treatment of step (c) results in a diffusion region between the primary layer and the secondary layer, which usually has a thickness of about 0.5% to about 10% of the total thickness of the primary layer and the secondary layer. As further described below, the primary and secondary layers can be applied by a single deposition technique, such as HVOF. This discovery represents an important processing advantage in a commercial setting.

A variety of specific compositions are sometimes used for the secondary layer. For example, the composition sometimes is made free of gamma phase material, by including aluminum in an amount in the range of about 25 atom % to about 55 atom %. A preferred composition often comprises an alloy of the following formula: 0 to about 25 atom % cobalt; about 7 atom % to about 20 atom % chromium; about 30 atom % to about 55 atom % aluminum; 0 to about 1 atom % yttrium; and 0 to about 2 atom % silicon, with the balance comprising nickel.

Another preferred composition for the secondary layer is sometimes used when greater toughness and ductility is desired. Such a composition comprises: 0 to about 25 atom % cobalt; about 15 atom % to about 25 atom % chromium; about 18 atom % to about 25 atom % aluminum; 0 to about 1 atom % yttrium; and 0 to about 2 atom % silicon, with the balance comprising nickel.

Another embodiment of this invention is directed to an article, comprising:

(i) a metal-based substrate;

(ii) a dense primary layer over the substrate, applied by a vacuum plasma spray technique or a high velocity oxy-fuel technique, wherein the primary layer material comprises an alloy of the formula MCrAlY, where M is selected from the group consisting of Fe, Ni, Co, and mixtures of any of the foregoing; and then

(iii) a dense secondary layer over the primary layer, applied by a vacuum plasma spray technique or by a high velocity oxy-fuel technique, wherein the secondary layer material comprises an alloy of the following formula: 0 to about 25 atom % cobalt; about 7 atom % to about 25 atom % chromium; about 18 atom % to about 55 atom % aluminum; 0 to about 1 atom % yttrium; and 0 to about 2 atom % silicon, with the balance comprising nickel.

As mentioned above, the substrate is often formed of a superalloy material, and can be a component of a turbine engine. A diffusion region is disposed between the primary layer and the secondary layer.

Further details regarding the features of this invention are found in the remainder of the specification.

### DETAILED DESCRIPTION OF THE INVENTION

Many different metals or metal alloys can be used as the substrate for the present invention. The term “metal-based” refers to those which are primarily formed of metal or metal alloys, but which may also include some non-metallic components, e.g., ceramics, intermetallic phases, or intermediate phases. Usually, the substrate is a heat-resistant alloy, e.g., superalloys which typically have an operating temperature of up to about 1000-

1150° C. (The term “superalloy” is usually intended to embrace complex cobalt- or nickel-based alloys which include one or more other elements, such as aluminum, tungsten, molybdenum, titanium, or iron.) Superalloys are described in various references, such as U.S. Pat. Nos. 5,399,313 and 4,116,723, both incorporated herein by reference. High temperature alloys are also generally described in Kirk-Othmer's Encyclopedia of Chemical Technology, 3rd Edition, Vol. 12, pp. 417-479 (1980), and Vol. 15, pp. 787-800 (1981). Nickel-base superalloys typically include at least about 40 wt % Ni. Illustrative alloys are designated by the trade names Inconel®, Nimonic®, Rene® (e.g., Rene® 80, Rene® 95 alloys), and Udimet®. Cobalt-base superalloys typically include at least about 30 wt % Co. Commercial examples are designated by the trade names Haynes®, Nozzaloy®, Stellite®, and Ultimet®. The actual configuration of a substrate may vary widely. For example, the substrate may be in the form of various turbine engine parts, such as combustor liners, combustor domes, shrouds, buckets, blades, nozzles, or vanes.

The primary layer which is first applied to the substrate usually comprises an alloy of the formula MCrAlY. “M” is selected from the group consisting of Fe, Ni, Co, and mixtures of any of the foregoing. These materials are known in the art. Some of the preferred alloys of this type have a broad composition (in weight percent) of about 17% to about 23% chromium; about 4% to about 13% aluminum; and about 0.1% to about 2% yttrium; with M constituting the balance. In some embodiments, M is a mixture of nickel and cobalt, wherein the ratio of nickel to cobalt is in the range of about 10:90 to about 90:10, by weight.

For this invention, the primary layer is frequently applied by a vacuum plasma spray (VPS) technique, or by a high velocity oxy-fuel technique. Both of these deposition processes are known in the art. Their use very often results in coating layers which are substantially dense, as described, for example, in U.S. patent application Ser. No. 09/385,544 (M. Borom et al; filed Aug. 30, 1999), which is incorporated herein by reference. In brief, VPS is usually carried out in a low-pressure environment, e.g., at about 20 torr to about 60 torr. Conventional VPS guns are available, e.g., an EPI 03CA gun from Electroplasma (Sulzer-METCO, Inc). Those of ordinary skill in the art are familiar with the various factors which relate to the use of this equipment, e.g., gun power; primary and secondary (if used) gas selection; gas flow rates; and the like.

HVOF techniques are known in the art and described, for example, in U.S. Pat. Nos. 5,508,097 and 5,527,591, both incorporated herein by reference. HVOF is a continuous combustion process in which the powder is injected into the jet stream of a spray gun at very high speeds. Those of ordinary skill in the art are familiar with typical HVOF details, which vary according to the specific type of spray gun used. Exemplary factors include: the selection of fuel gasses; gas flow rates; coating particle size, and the like. In some embodiments, HVOF is the most preferred deposition technique for the primary layer.

The thickness of the primary layer will depend in part on the conditions to which the final, coated article will be subjected, as well as other factors, such as the level of oxidation protection and corrosion resistance required for the article. Usually, the thickness will be in the range of about 100 microns to about 350 microns, and preferably, in the range of about 150 microns to about 250 microns.

The secondary layer is then applied over the primary layer. The same deposition techniques can be used, with HVOF being especially preferred in some embodiments. For this invention, it is important that the secondary layer comprise a beta phase, which is usually NiAl, CoAl, or mixtures thereof. In some embodiments, it is also preferable that the secondary layer further comprise an alpha-chrome phase.

One secondary layer material conforming to these requirements comprises an alloy of the following formula:

0 to about 25 atom % cobalt;

about 7 atom % to about 25 atom % chromium;

about 18 atom % to about 55 atom % aluminum;

0 to about 1 atom % yttrium; and

0 to about 2 atom % silicon,

with the balance comprising nickel.

When oxidation resistance is a very high priority, it is sometimes preferred that the secondary layer be substantially free of gamma phase material, e.g., solid solutions of nickel or cobalt. In that instance, the range of aluminum would be about 25 atom % to about 55 atom %.

Another preferred alloy of this type comprises:

0 to about 25 atom % cobalt;

about 7 atom % to about 20 atom % chromium;

about 30 atom % to about 55 atom % aluminum;

0 to about 1 atom % yttrium; and

0 to about 2 atom % silicon,

with the balance comprising nickel.

In some especially preferred embodiments, the alloy comprises:

0 to about 25 atom % cobalt;

about 7 atom % to about 15 atom % chromium;

about 35 atom % to about 55 atom % aluminum;

0 to about 1 atom % yttrium; and

0 to about 2 atom % silicon,

with the balance comprising nickel.

In other embodiments of the present invention, the alloy for the secondary layer is quite similar in composition and phase distribution to the MCrAlY material described previously. This type of layer generally exhibits greater toughness and ductility than the secondary layer materials described above. The material comprises:

0 to about 25 atom % cobalt;

about 15 atom % to about 25 atom % chromium;

about 18 atom % to about 25 atom % aluminum;

0 to about 1 atom % yttrium; and

0 to about 2 atom % silicon,

with the balance comprising nickel.

This type of secondary layer is very useful for protective coating systems in which high ductility is a priority, e.g., those systems which are subjected to a considerable amount of thermal cycling. In such an application, a preferred composition of this type is as follows:

0 to about 25 atom % cobalt;

about 17 atom % to about 22 atom % chromium;

about 18 atom % to about 22 atom % aluminum;

0 to about 1 atom % yttrium; and

0 to about 2 atom % silicon,

with the balance comprising nickel.

Those of skill in the metallurgical arts are generally familiar with methods for preparing powders of the alloys described above. An exemplary reference is the Metals Handbook, Desk Edition, published by the American Society for Metals, 1985. Examples of the individual processing steps include: mixing powders of each component; melting the mixture to form ingots of the alloy material, and then crushing or gas-atomizing the ingots. The resulting material can then be sized by conventional techniques. Adjustment can be made in the individual processing steps to suit a particular alloy composition, without undue effort.

Alloyed materials which contain relatively high levels of the beta phase, i.e., NiAl or CoAl, usually have relatively high melting points, e.g., greater than about 1600° C. These types of materials (which can be referred to as “intermetallic compounds”) are usually processed at relatively high temperatures. One exemplary technique for processing such materials is described in U.S. Pat. No. 5,330,701, issued to K. Shaw et al, and incorporated herein by reference. The Shaw patent is directed to a reactive sintering process for producing a finely divided intermetallic material. In this process, the reactants are intimately mixed. A portion of the mixture (in a protective atmosphere) is then brought up to a temperature sufficient to initiate an exothermic reaction, and to form a transient liquid phase. A heat sink is used to produce a layered body of the compound. The layered body is then cooled in the protective atmosphere, followed by comminution, to form a finely-divided intermetallic powder. The powder is then sized.

The thickness of the secondary layer will depend on many of the factors discussed above with respect to the first layer, e.g., the desired level of oxidation- and corrosion protection. Usually, the thickness will be in the range of about 35 microns to about 85 microns, and preferably, in the range of about 45 microns to about 75 microns.

After the deposition of the secondary layer, the article is subjected to a heat treatment. This treatment diffuses a portion of the secondary layer into the primary layer, forming a diffusion region. The diffusion region is important for several reasons. It improves adhesion between the layers, reducing the propensity for delamination of the second layer from the first. Moreover, the heat treatment itself provides stress relief between the layers, while also homogenizing the particle compositions at the interface between the two layers.

The particular conditions for the heat treatment will depend on various factors. These include the desired thickness of the diffusion region, as well as the thickness and particular composition of the primary and secondary layers. Moreover, heat treatment conditions for the substrate metal (e.g., ageing and solution heat-treatments) should also be taken into consideration, since it is usually undesirable to substantially change the properties of the substrate material as a result of this particular heat treatment.

Usually, the heat treatment will be carried out at a temperature in the range of about 850° C. to about 1250° C., and preferably, in the range of about 950° C. to about 1150° C.

The duration of the heat treatment will usually be in the range of about 1 hour to about 10 hours, and preferably, about 2 hours to about 6 hours. Longer heating times often compensate for lower temperatures, while higher temperatures (within the general ranges set forth above) often compensate for shorter heating times.

The thickness of the diffusion region will depend in part on the thickness of the primary and secondary layers. For example, the diffusion region thickness should not consume an excessive amount of either of the adjacent layers. The average thickness of the diffusion region is often about 0.5% to about 10% of the total thickness of the primary layer and the secondary layer.

Another embodiment of this invention is directed to a method for repairing a worn or damaged protective coating system applied over a metal-based substrate, e.g., a turbine engine component or portion thereof. (As used herein, a “protective coating system” includes at least two coating layers, i.e., the primary and secondary layers discussed above). First, the worn or damaged protective coating system is removed from a selected area on the substrate. The coating may be removed by various techniques known in the art, such as chemical stripping (e.g., with acids); electrochemical stripping; grinding; fluoride-ion etching, and the like.

A replacement-protective coating system is then deposited on the repair site, according to the technique discussed previously. In other words, a primary layer is first applied to the substrate by a vacuum plasma spray technique, or by an HVOF technique. The primary layer alloy comprises an alloy of the formula MCrAlY, where M is selected from the group consisting of Fe, Ni, Co, and mixtures of any of the foregoing. A secondary layer is then applied to the primary layer by a vacuum plasma spray technique, or by an HVOF technique. (As mentioned above, HVOF is the preferred deposition technique in certain embodiments). The applied layers are then heat-treated according to the guidelines described previously. The repaired component is then ready to be returned to service. It should be noted that the use of the same deposition system for both the primary and secondary layers greatly streamlines the repair process. This advantage is especially significant when the repair has to be carried out at a location in which a variety of coating deposition systems may not be available.

### EXAMPLES

The following example is merely illustrative, and should not be construed to be any sort of limitation on the scope of the claimed invention.

Various protective coating systems were applied to superalloy samples, as described below. The samples were evaluated for oxidation resistance, corrosion resistance, and resistance-to-cracking. Air furnace and burner rig tests were carried out for oxidation resistance and corrosion resistance, using cylindrical pins as the test samples. The pins were cut by EDM (electro-discharge machining) from a 6 inch-long (15.2 cm) bar of a standard nickel-base superalloy. Each resulting pin had a length of 0.92 in. (2.3 cm), and a diameter of 0.17 in. (0.4 cm). (As described below, flat bars were used for strain-to-crack tests).

The coating system which constituted sample A was based on the present invention. A set of the pins were prepared for burner rig testing, using standard pre-treatment techniques, i.e., grit-blasting and ultrasonic cleaning in alcohol. The primary layer was formed of an MCrAlY-type material having the following nominal composition: 32 wt % Ni, 35.7 wt % Co, 22 wt % Cr, 10 wt % Al, and 0.3 wt % Y. The composition was used in powder form, in which the average particle size was about 20-44 microns.

The primary layer was deposited by a standard HVOF system, using a METCO DJ-2600HVOF gun. For the burner rig pins, the HVOF conditions were as follows: The oxidizing gas was oxygen, with a flow rate of about 350-500 scfh. The fuel gas was hydrogen, with a flow rate of about 1400-1800 scfh. A cooling gas was also used, with a flow rate of about 700-900 scfh. A powder carrier gas (nitrogen) was also injected, with a flow rate of about 15-30 scfh.

The spray distance was about 9 in. (22.9 cm), and each pin was spun at 1200 r.p.m. The gun transverse speed was about 70-100 mm/sec. The thickness of the coating was about 10 mils (253 microns).

The secondary layer for sample A was deposited by the same HVOF system. The composition used for this layer comprised the following components: 29.5 wt % Ni, 30.3 wt % Co, 9.7 wt % Cr, 30 wt % Al, and 0.2 wt % Si. This composition corresponds approximately as follows: 21.9 atom % Ni; 21.9 atom % Co; 8.3 atom % Cr; 47.8 atom % Al; and 0.1 atom % Si. The composition was prepared by the reactive sintering process described earlier and set forth in U.S. Pat. No. 5,330,701. In applying this material, the flow rate of the oxidizing gas (oxygen) was about 450-550 scfh. The hydrogen fuel gas had a flow rate of about 1640 scfh. A cooling gas was also used, with a flow rate of about 700-800 scfh. A powder carrier gas (nitrogen) was injected, with a flow rate of about 15-30 scfh. The spray distance was about 9 in. (22.9 cm), and each pin was spun at 1200 r.p.m. The gun transverse speed was about 70-100 mm/sec. The thickness of the resulting coating was about 3 mils (76 microns).

After the application of the two layers, the pins were vacuum heat-treated at 1079° C. for about 4 hours. The pins were then cut into 0.92 in. (2.3 cm) segments by EDM. The open ends of the pins were then HVOF-coated with about 3 mils (76 microns) of the secondary layer material, under the same process parameters used to apply that layer. The pins were then subjected to another vacuum heat-treatment, for 2 hours at 1079° C.

The coating system which constituted sample B was outside the scope of this invention, and used for the purpose of comparison. The primary layer was identical to the MCrAlY-type material used for sample A. It was applied by the same HVOF system, using identical spray conditions. Its thickness was 10 mils (253 microns).

An aluminide-type secondary layer was then applied over the primary layer. The secondary coating was deposited by a conventional pack-aluminide (cementation) process, utilizing an aluminum source powder and a halide activator. Aluminiding was carried out for about 4 hours, at 1925° F (1052° C). The average coating thickness for the secondary layer was about 2.7 mils (68.6 microns). The nominal aluminum content of this secondary layer was similar to that of the secondary layer of sample A, i.e., within about 2 wt %.

After the application of the two layers, the pins were cut into 0.92 in. (2.3 cm segments), as in the case of the sample A pins. The open ends of the pins were then aluminided (by the pack process mentioned above) to an average thickness of about 3 mils (76 microns).

Samples in the shape of flat bars were used for the strain-to-crack tests. Multiple samples were coated in the same manner, with the same material as that described for samples A and B. The bars had dimensions of 7 in. (17.8 cm)×2 in. (5.1 cm)×⅛ in. (0.3 cm). The strain-to-crack test was carried out to determine the coating's ductility, i.e., by evaluating its resistance to cracking. In this test, one end of the bar is fastened, and a load is placed on the other end in a manner which permits a constant deflection (0.7 in./1.8 cm) to be applied to the bar, in cantilever fashion. The resulting strain varies continuously along the length of the bar, and the strain values along its length are recorded. As shown in the chart which follows, each bar is heated to a particular temperature level. (In other words, different samples, prepared and coated in the same manner, were tested at each temperature). An examination of each bar for cracking was carried out after the temperature exposure. The lowest strain level at which cracking occurs is determined by the location of the cracks furthest from the fixed end of the bar.

Oxidation resistance and corrosion resistance were measured by subjecting the pins (the 0.92 in. pins) to certain environmental conditions in an air furnace or a burner rig apparatus. The air furnace was a conventional electric unit. Burner rig testing is known in the art and generally described, for example, in U.S. Pat. No. 5,922,409 (McMordie et al). In the present burner rig set-up, two types of fuel can be combusted: natural gas for oxidation testing, and hydrocarbon distillate (containing prescribed amounts of contaminants) for the corrosion tests. The temperatures in the rigs are maintained by the use of electrical resistance furnaces which totally surround the test area. The temperatures are measured and calibrated by thermocouples attached to the burner rig stands. Each burner rig held about 21 of the pins, and the duration of the pins in each furnace is listed in Table 1.

For the hot corrosion tests, synthetic sea water (i.e., NaCl-based) was added to the distillate fuel supply (146 cc per 4 gal. fuel), along with di-tert-butyl sulfide (278 cc per 4 gal. fuel), and a conventional dispersing agent. The operating conditions for this test were sufficient to produce hot corrosion attack on the pins. After the designated exposure time in this hot corrosion environment (see Table 1), the extent of attack was determined by metallography. Each pin was sectioned into two halves at the location of maximum corrosion. Depth of penetration of the corrosion was measured directly from the polished cross-section of the pin which exhibited the greatest amount of metal consumption. (The table also indicates measurements which were based on average penetration for the two halves of each pin).

The results which relate to oxidation resistance and corrosion resistance are also found in Table 1. (Both characteristics can be evaluated by the depth of penetration).

TABLE 1

| | | | | | Max. | Max |
|---|---|---|---|---|---|---|
| Pin | | Appa- | Temperature | Time | Penetration^{c} | Penetration^{d} |
| #* | Sample^{a} | ratus^{b} | (° F./° C.) | (hrs) | (mils/μ) | (in./cycle) |
| 1 | A | Bur. | 1600/871 | 896 | 6.2/157 | 6.96E−06 |
| 2 | A | Bur. | 1600/871 | 1154 | 2.6/66 | 2.92E−06 |
| 3 | B | Bur. | 1600/871 | 1216 | 4.4/112 | 3.62E−06 |
| 4 | A | Fur. | 1700/927 | 1975 | 0.9/23 | 4.68E−07 |
| 5 | A | Fur. | 1700/927 | 4000 | 0.8/20 | 2.07E−07 |
| 6 | B | Fur. | 1700/927 | 1975 | 2.0/51 | 1.00E−06 |
| 7 | B | Fur. | 1700/871 | 4000 | 1.0/25 | 2.60E−07 |
| 8 | A | Fur. | 1800/982 | 2015 | 1.4/36 | 7.13E−07 |
| 9 | B | Fur. | 1800/982 | 2015 | 0.8/20 | 3.73E−07 |
| 10 | A | Fur. | 1900/1038 | 2139 | 1.9/48 | 9.00E−07 |
| 11 | A | Bur. | 1900/1038 | 4048 | 1.0/25 | 2.44E−07 |
| 12 | B | Fur. | 1900/1038 | 2139 | 1.2/30 | 5.43E−07 |
| 13 | B | Bur. | 1900/1038 | 4048 | 0.9/23 | 2.11E−07 |
| 14 | A | Fur. | 2000/1093 | 2021 | 0.9/23 | 4.68E−07 |
| 15 | B | Fur. | 2000/1093 | 2021 | 2.1/53 | 1.06E−06 |

*Pins 1-3 were subjected to hot corrosion tests, using distillate fuel. Pins 4-15 were subjected to oxidation tests.
^{a}“A” = present invention, i.e., HVOF primary layer/HVOF secondary layer; “B” = comparative (base-line) example, i.e., HVOF primary layer/pack-aluminided secondary layer.
^{b}“Bur.” = burner rig apparatus; “Fur.” = conventional air furnace.
^{c}Maximum penetration per pin-side.
^{d}Maximum penetration per hour, per pin-side, based on average of two halves of pin. (“E” = exponent).

* Pins 1-3 were subjected to hot corrosion tests, using distillate fuel. Pins 4-15 were subjected to oxidation tests.

a) “A”=present invention, i.e., HVOF primary layer/HVOF secondary layer; “B”=comparative (base-line) example, i.e., HVOF primary layer/pack-aluminided secondary layer.

b) “Bur.”=burner rig apparatus; “Fur.”=conventional air furnace.

c) Maximum penetration per pin-side.

d) Maximum penetration per hour, per pin-side, based on average of two halves of pin. (“E”=exponent).

In general, the coating system of the present invention performed as well as the prior art coating system, although there is some variation in penetration levels over time and temperature. The data presented in Table 1 is representative of the range of data scatter typically associated with metal penetration tests of this type.

The strain-to-crack results are provided below in Table 2:

TABLE 2

| | | | Distance | |
|---|---|---|---|---|
| | | Temperature | to Last Crack | |
| Pin # | Sample^{a} | (° F./° C.) | (in./cm)^{b} | Strain (cm/cm, x 10−²⁾ |
| 1 | A | 1300/704 | 1.7/4.3 | 0.735 |
| 2 | A | 1350/732 | None* | — |
| 3 | A | 1400/760 | None* | — |
| 4 | A | 1500/816 | None* | — |
| 5 | B | 1300/704 | 3.5/9.0 | 0.338 |
| 6 | B | 1350/732 | None* | — |
| 7 | B | 1400/760 | None* | — |
| 8 | B | 1600/871 | None** | — |

^{a}“A” = present invention, i.e., HVOF primary layer/HVOF secondary layer; “B” = comparative example, i.e., HVOF primary layer/pack-aluminided secondary layer.
^{b}Distance from fastening point (“grip”) of bar, subtracting length encompassed by fastening device.
*No detectable crack.
**No detectable crack, based on data from a separate, but comparable experiment.

a) “A”=present invention, i.e., HVOF primary layer/HVOF secondary layer; “B”=comparative example, i.e., HVOF primary layer/pack-aluminided secondary layer.

b) Distance from fastening point (“grip”) of bar, subtracting length encompassed by fastening device.

* No detectable crack.

**No detectable crack, based on data from a separate, but comparable, experiment.

Samples A and B exhibited no cracking at temperatures greater than 1350° F. (732° C.). This result demonstrates that the samples are comparable to those of the prior art, in terms of ductility (i.e., strain tolerance) at elevated temperatures. At 1300° F. (704° C.), the strain level at the site of cracking for Sample A was over twice that of sample B, indicating that Sample A is much more strain-tolerant than Sample B at that temperature.

In general, the data of Table 2 show that the strain-to-crack performance for samples of this invention exceeded that of the prior art samples. (These results can be influenced in part by the level of aluminum in the secondary layer). The data in Table 1 demonstrated comparable levels for the other properties, i.e., oxidation resistance and corrosion resistance.

Moreover, properties for the samples of the present invention can be achieved by the use of a single deposition system for the protective coatings. As described previously, this discovery represents an important processing advantage when applying new coating systems to various components, and when repairing previously-applied coating systems.

Having described preferred embodiments of the present invention, alternative embodiments may become apparent to those skilled in the art without departing from the spirit of this invention. Accordingly, it is understood that the scope of this invention is to be limited only by the appended claims.

All of the patents, articles, and texts mentioned above are incorporated herein by reference.

What is claimed:

1. A method for providing environmental protection to a metal-based substrate, comprising the following steps:
(a) applying a primary layer to the substrate by a vacuum plasma spray technique or by a high velocity oxy-fuel technique, wherein the primary layer material comprises an alloy of the formula MCrAlY, where M is selected from the group consisting of Fe, Ni, Co, and mixtures of any of the foregoing;
(b) applying a secondary layer to the primary layer by a vacuum plasma spray technique or by a high velocity oxy-fuel technique, wherein the secondary layer material comprises an alloy of the following formula: 0 to about 25 atom % cobalt; about 7 atom % to about 25 atom % chromium; about 18 atom % to about 55 atom % aluminum; 0 to about 1 atom % yttrium; and 0 to about 2 atom % silicon, with the balance comprising nickel; and then
(c) heat-treating the applied layers.

2. The method of claim 1, wherein the heat treatment of step (c) results in a diffusion region between the primary layer and the secondary layer.

3. The method of claim 2, wherein the heat treatment is carried out at a temperature in the range of about 850° C. to about 1250° C., for a time period of between about 60 minutes and about 10 hours.

4. The method of claim 2, wherein the diffusion region has an average thickness which is about 0.5% to about 10% of the total thickness of the primary layer and the secondary layer.

5. The method of claim 1, where M is a mixture of nickel and cobalt.

6. The method of claim 1, wherein the amount of aluminum in the secondary layer material is in the range of about 25 atom % to about 55 atom %.

7. The method of claim 1, where the secondary layer material comprises an alloy of the following formula: 0 to about 25 atom % cobalt; about 7 atom % to about 20 atom % chromium; about 30 atom % to about 55 atom % aluminum; 0 to about 1 atom % yttrium; and 0 to about 2 atom % silicon, with the balance comprising nickel.

8. The method of claim 1, wherein the secondary layer material comprises an alloy of the following formula: 0 to about 25 atom % cobalt; about 15 atom % to about 25 atom % chromium; about 18 atom % to about 25 atom % aluminum; 0 to about 1 atom % yttrium; and 0 to about 2 atom % silicon, with the balance comprising nickel.

9. The method of claim 1, wherein the metal-based substrate is formed of a material which comprises a superalloy.

10. A method for providing oxidation resistance and corrosion resistance to a nickel-base superalloy substrate, comprising the following steps:
(a) applying a primary layer to the substrate by a high velocity oxy-fuel technique, wherein the primary coating material comprises an alloy of the formula MCrAlY, where M is selected from the group consisting of Fe, Ni, Co, and mixtures of any of the foregoing;
(b) applying a secondary layer to the primary layer by a high velocity oxy-fuel technique, wherein the secondary layer material comprises an alloy of the following formula: 0 to about 25 atom % cobalt; about 7 atom % to about 25 atom % chromium; about 18 atom % to about 55 atom % aluminum; 0 to about 1 atom % yttrium; and 0 to about 2 atom % silicon, with the balance comprising nickel; and then
(c) heat-treating the applied layers, to diffuse a portion of the secondary layer into the primary layer, forming a diffusion region that has an average thickness which is about 0.5% to about 10% of the total thickness of the primary layer and the secondary layer.

11. The method of claim 10, wherein the substrate is a component of a turbine engine.

12. A method for repairing a worn or damaged protective coating system applied over a metal-based substrate, comprising the following steps:
(i) removing the worn or damaged protective coating system from a selected area on the substrate;
(ii) applying a primary layer over the selected area by a vacuum plasma spray technique or by a high velocity oxy-fuel technique, wherein the primary layer material comprises an alloy of the formula MCrAlY, where M is selected from the group consisting of Fe, Ni, Co, and mixtures of any of the foregoing;
(iii) applying a secondary layer to the primary layer by a vacuum plasma spray technique or by a high velocity oxy-fuel technique, wherein the secondary layer material comprises an alloy of the following formula: 0 to about 25 atom % cobalt; about 7 atom % to about 25 atom % chromium; about 18 atom % to about 55 atom % aluminum; 0 to about 1 atom % yttrium; and 0 to about 2 atom % silicon, with the balance comprising nickel; and then
(iv) heat-treating the applied layers.

13. An article, comprising:
(i) a metal-based substrate;
(ii) a dense primary layer over the substrate, applied by a vacuum plasma spray technique or a high velocity oxy-fuel technique, wherein the primary layer material comprises an alloy of the formula MCrAlY, where M is selected from the group consisting of Fe, Ni, Co, and mixtures of any of the foregoing; and
(iii) a dense secondary layer over the primary layer, applied by a vacuum plasma spray technique or by a high velocity oxy-fuel technique, wherein the secondary layer material comprises an alloy of the following formula: 0 to about 25 atom % cobalt; about 7 atom % to about 25 atom % chromium; about 18 atom % to about 55 atom % aluminum; 0 to about 1 atom % yttrium; and 0 to about 2 atom % silicon, with the balance comprising nickel.

14. The article of claim 13, wherein the metal-based substrate comprises a superalloy material.

15. The article of claim 13, wherein the amount of aluminum in the secondary layer material is in the range of about 25 atom % to about 55 atom %.

16. The article of claim 13, wherein the secondary layer material comprises an alloy of the following formula: 0 to about 25 atom % cobalt; about 7 atom % to about 20 atom % chromium; about 30 atom % to about 55 atom % aluminum; 0 to about 1 atom % yttrium; and 0 to about 2 atom % silicon, with the balance comprising nickel.

17. The article of claim 13, wherein the secondary layer material comprises an alloy of the following formula: 0 to about 25 atom % cobalt; about 15 atom % to about 25 atom % chromium; about 18 atom % to about 25 atom % aluminum; 0 to about 1 atom % yttrium; and 0 to about 2 atom % silicon, with the balance comprising nickel.

18. The article of claim 13, wherein a diffusion region is disposed between the primary layer and the secondary layer.

19. The article of claim 18, wherein the diffusion region has an average thickness which is about 0.5% to about 10% of the total thickness of the primary layer and the secondary layer.

20. The article of claim 13, wherein the primary layer has a thickness in the range of about 100 microns to about 350 microns.

21. The article of claim 13, wherein the secondary layer has a thickness in the range of about 35 microns to about 85 microns.

22. An article, comprising:
(i) a superalloy substrate;
(ii) a dense primary layer over the substrate, applied by an HVOF technique, and comprising an alloy of the formula MCrAlY, where M is selected from the group consisting of Fe, Ni, Co, and mixtures of any of the foregoing;
(iii) a dense secondary layer over the primary layer, and applied by an HVOF technique, wherein the secondary layer material comprises an alloy of the following formula: 0 to about 25 atom % cobalt; about 7 atom % to about 20 atom % chromium; about 30 atom % to about 55 atom % aluminum; 0 to about 1 atom % yttrium; and 0 to about 2 atom % silicon, with the balance comprising nickel.

23. The article of claim 22, wherein the substrate is a component of a turbine engine.

24. An article, comprising:
(i) a superalloy substrate;
(ii) a dense primary layer over the substrate, applied by an HVOF technique, and comprising an alloy of the formula MCrAlY, where M is selected from the group consisting of Fe, Ni, Co, and mixtures of any of the foregoing;
(iii) a dense secondary layer over the primary layer, and applied by an HVOF technique, wherein the secondary layer material comprises an alloy of the following formula: 0 to about 25 atom % cobalt; about 15 atom % to about 25 atom % chromium; about 1 atom % to about 25% atom % aluminum; 0 to about 1 atom % yttrium; and 0 to about 2 atom % silicon, with the balance comprising nickel.

25. The article of claim 24, wherein the substrate is a component of a turbine engine.
